(19) United States
(12) Patent Application Publication
(10) Pub. No.: US 2007/0156881 A1
(43) Pub. Date: Jul. 5, 2007

(54) METHOD FOR CHECKING VEHICLE STATUS IN HOME TELEMATICS SYSTEM

(76) Inventor: Seong Taeg NOU, Icheon-Shi (KR)

Correspondence Address: IPLA P.A., 3580 WILSHIRE BLVD., 17TH FLOOR, LOS ANGELES, CA, 90010, US

(21) Appl. No.: 11/428,298

(22) Filed: Jun. 30, 2006

(30) Foreign Application Priority Data
Jan. 2, 2006 (KR) 10-2006-0000107

(51) Int. Cl. G06F 15/173

(52) U.S. Cl. 709/223

(57) ABSTRACT

Provided a method for checking a vehicle status in a home telematics system. The method includes steps of requesting for a vehicle state check service; transmitting an authentication request message having a telephone number and authentication information; comparing authentication information associated with the telephone number, with the authentication information of the authentication request message, and executing authentication; upon success of the authentication, transmitting a service ready message of informing that service is ready; sending a session connection request, and executing session connection; transmitting a vehicle status check message in a session connection state; and receiving the vehicle status check message, collecting vehicle status information, and transmitting a vehicle status information message having the vehicle status information.

### BACKGROUND OF THE INVENTION

1. Field of the Invention

The present invention relates to a home telematics system, and more particularly, to a method for checking a vehicle status in a home telematics system, for checking the vehicle status by a home network terminal using home network system and telematics system.

2. Description of the Related Art

In recent years, a telematics system is one of technologies attracting attention. The telematics system detects occurrence of vehicle accident or theft, guides a vehicle running path, and provides a vehicle driver with a variety of other information using a mobile communication method and a position tracing method associated with Internet. In other words, the telematics system provides information through a vehicle based on a global positioning system (GPS) using a mobile communication system and a GPS satellite. Accordingly, the telematics system provides the vehicle driver with a variety of mobile communication services, such as traffic information, countermeasure to an emergency situation, remote vehicle diagnosis, use of Internet (for example, financial transaction, provision of news, and transmission and reception of e-mail), using the GPS, a wireless communication network and an Internet network.

Further, in the telematics system, various technologies associated with conventional various systems are being proposed and promoted. One of them is a home telematics system associating with a telematics system and a home network system. In general, the home network system is capable of remotely checking or controlling status of a light, a gas valve, a door, and a heater/air conditioner within a home, using a mobile communication network.

In order to invigorate the home telematics system providing various services in association with the telematics system and the home network system, various contents are required for development.

### SUMMARY OF THE INVENTION

Accordingly, the present invention is directed to a method for checking a vehicle status in a home telematics system that substantially overcomes one or more of the limitations and disadvantages of the conventional art.

One object of the present invention is to provide a method for checking a vehicle status in a home telematics system, for checking the vehicle status by a home network terminal, using home network system and telematics system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a method for checking a vehicle status in a home telematics system having a home network terminal, a home server, a home network management server, a telematics center, and a telematics terminal.

The method includes steps of: in the home server, requesting the home network terminal for a vehicle state check service; in the home network management server, transmitting an authentication request message having a telephone number and authentication information of the telematics terminal, to the telematics center; in the telematics center, comparing authentication information of the telematics terminal associated with the telephone number, with the authentication information of the authentication request message, and executing authentication; in the home network management server, upon success of the authentication, transmitting a service ready message of informing that service is ready, to the home server; in the home server, sending a session connection request to the telematics terminal, and executing session connection; in the home server, transmitting a vehicle status check message to the telematics terminal in a session connection state; and in the telematics terminal, receiving the vehicle status check message, collecting vehicle status information, and transmitting a vehicle status information message having the collected vehicle status information, to the home server.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a home telematics system according to the present invention;

FIG. 2 illustrates a construction of a telematics terminal according to the present invention; and

FIG. 3 is a flowchart illustrating a method for checking a vehicle status in a home telematics system according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the present invention, a home telematics subscriber can check a variety of vehicle status information such as opening/closing states of car door, trunk, and hood, and an on/off state of a light, in a home network terminal such as a personal computer (PC) or a personal digital assistant (PDA) using a home telematics system.

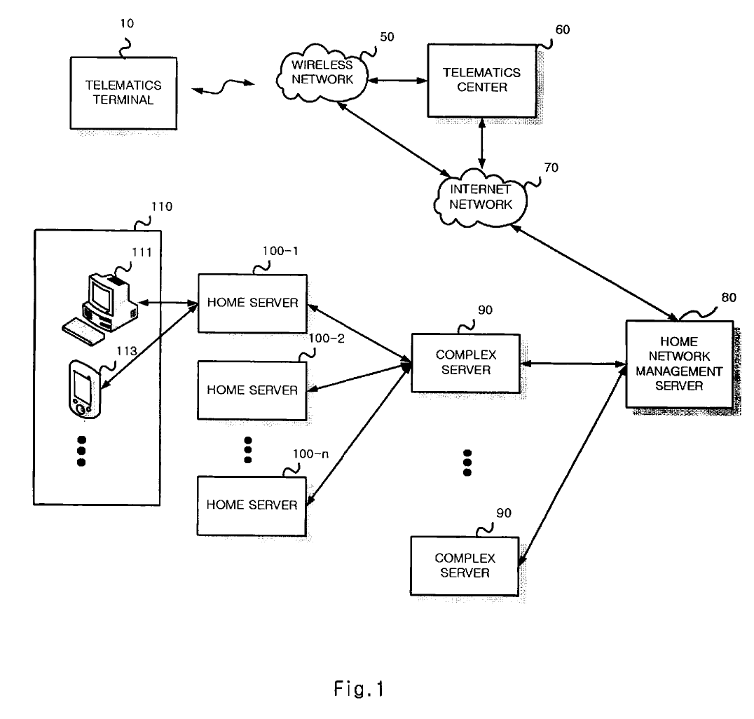

FIG. 1 illustrates a construction of the home telematics system according to the present invention.

Referring to FIG. 1, the inventive home telematics system includes a telematics terminal 10, a wireless network 50, a telematics center 60, an Internet network 70, a home network management server 80, a plurality of complex servers 90, a plurality of home servers 100, and a plurality of home network terminals 110.

The home network terminal 110 includes a local area network (LAN) card or a data communication module such as Bluetooth and infrared data association (IrDA) to perform a data communication with the home server 100. The home network terminal 110 includes application program for receiving the data communication with and a plurality of services from the home server 100.

The home server 100 has identification information such as media access control (MAC) addresses of the plurality of home network terminals 110. The home server 100 includes a communication module associated with the data communication module of the home network terminal 110 to perform the data communication with the home network terminal 110. The home server 100 connects with the home network management server 80 through the complex server 90 to perform a data communication based on a home network protocol.

The home network management server 80 includes a home network client information database storing Internet protocol (IP) information on the complex servers 90 and the home servers 100 and information on respective home server 100 users, that is, clients. When the telematics terminal 10 receives a service request, the home network management server 80 executes authentication with the telematics center 60, and performs a data communication based on a TCP/IP protocol with the telematics center 60 using the Internet network 70.

The telematics center 60 includes a telematics client information database having all client information inclusive of a telematics terminal 10 number, authentication information, and bill information. The telematics center 60 provides various services to the plurality of telematics terminals 10. When the home server 100 receives the service request, the telematics center 60 executes the authentication with the home network management server 80, and performs a data communication between the telematics terminal 10 and the home network management server 80.

The telematics terminal 10 receives each position data from a plurality of global positioning system (GPS) satellites to measure its position. The telematics terminal 10 performs a data communication with an electronic control unit (ECU) and a transmission control unit (TCU) provided within a car, and collects the vehicle status information such as the opening/closing states of the car door, trunk, and hood, the on/off state of the light such as a headlight, a rear light, and a fog light, a starting state, the existence and nonexistence of a passenger within the car, and an airbag state. The telematics terminal 10 connects with the telematics center 60 through the wireless network 50, and receives various services such as a traffic information service.

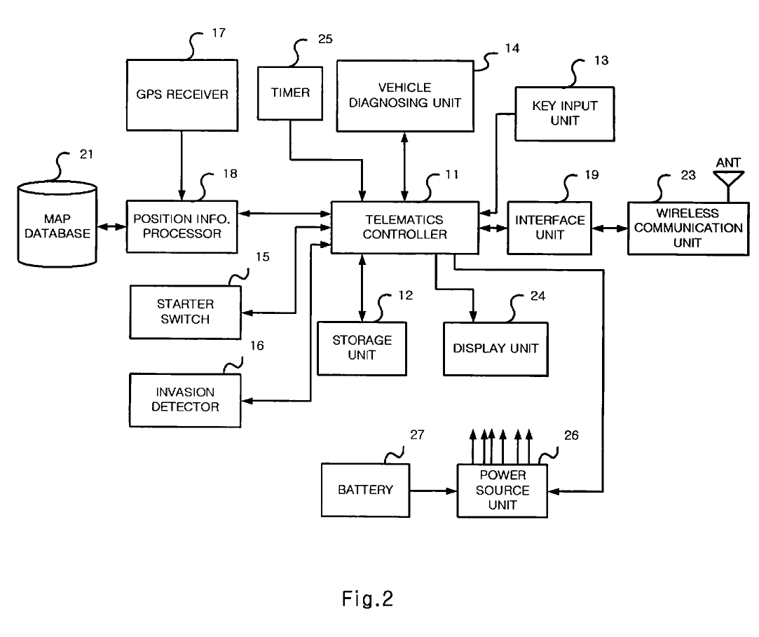

FIG. 2 illustrates a construction of the telematics terminal according to the present invention. A construction and an operation of the telematics terminal will be described below with reference to FIG. 2.

The telematics terminal 10 includes a telematics controller 11, a storage unit 12, a key input unit 13, a vehicle diagnosing unit 14, a starter switch 15, an invasion detector 16, a GPS receiver 17, a position information processor 18, an interface unit 19, a map database 21, a wireless communication unit 23, a display unit 24, a power source unit 26, and a battery 27. The wireless communication unit 23 can be constructed in a built-in type. The built-in type can directly connect with the telematics controller 11.

The telematics controller 11 controls a general operation of the telematics terminal 10.

The storage unit 12 includes a region for storing control program to control an operation of the telematics terminal, a region for temporarily storing data generated in execution of the control program, and a region for storing data such as authentication password used for authentication, vehicle diagnosis information, and vehicle position information.

The key input unit 13 includes a plurality of numeric keys or character keys, a function key, a mode key, an end key, and a power key, and generates and outputs key data on the keys.

The vehicle diagnosing unit 14 detects a status signal of each constituent part of the car from a plurality of sensors that are positioned at external or internal constituent parts of the car, and inputs the detected signal to the telematics controller 11. The vehicle diagnosing unit 14 can directly connect with the plurality of sensors and receive the status signal, or can receive the status signal of each part of the car through the ECU and the TCU connecting with the plurality of sensors. The sensors can be exemplified as a collision sensor for sensing collision in front or rear of the car, an airbag sensor for sensing activation of the airbag when a sensing value inputted from the collision sensor is greater than a predetermined value, a sensor for checking an amount of car oil, and a sensor for sensing an opening and closing of car window, door, and trunk. The vehicle diagnosing unit 14 generates vehicle status information using vehicle status signals, and outputs the generated status information to the telematics controller 11.

The display unit 24, a display device such as a liquid crystal display (LCD) or a touch screen, displays a variety of information such as a telematics operation mode and status and a car status by graphic or text under the control of the telematics controller 11.

The timer 25 counts time, and provides counted time information to the telematics controller 11.

The interface unit 19 connects with a universal asynchronous transceiver and receiver (UART)(not shown) of the wireless communication unit 23, and wirelessly connects the telematics terminal 10 with a wireless base station.

The starter switch 15 supplies a power source to the car or starts on/off the car after the supply of the power source, under the control of the telematics controller 11. In diagnosing a vehicle status, there are constituent parts not able to measure the status until the telematics terminal 11 and the car are activated. Thus, the telematics controller 11 should control the starter switch 15 to supply the power source to the car and allow the car to be in a start on state.

The invasion detector 16 detects a moving object within the car, and detects whether or not there is an invader. The invasion detector 16 can employ a pressure sensor or an infrared ray sensor. The invasion detector 16 can digitalize a value outputted from the sensors and output the digitalized value, or can output only detection or non-detection (0 or 1). The invasion detector 16 can be also constructed integrally with the vehicle diagnosing unit 14.

The map database 21 stores map data including a road and a building classified by position. The GSP receiver 17 receives position information from the plurality of artificial satellites 60, and outputs the received position information to the position information processor 18. The position information processor 18 receives the position information from the GPS receiver 17, reads the map data on a position of the received position information from the map database 21, and outputs the read map data to the telematics controller 11.

The power source unit 26 receives the power source from the car battery 27, converts the received power source into an operation power for operating the telematics terminal, and provides the converted power to each of the constituent parts. When the power key of the key input unit 13 is pressed, the power source unit 26 switches on/off the power source supplied to the telematics terminal 10 under the control of the telematics controller 11.

Upon the receipt of a vehicle status check message through the wireless communication unit 23 in a connection state with the home server 100, the telematics controller 10 transmits a vehicle status information message including vehicle status information collected by the vehicle diagnosing unit 14 and invasion information detected by the invasion detector 16, to the home server 100.

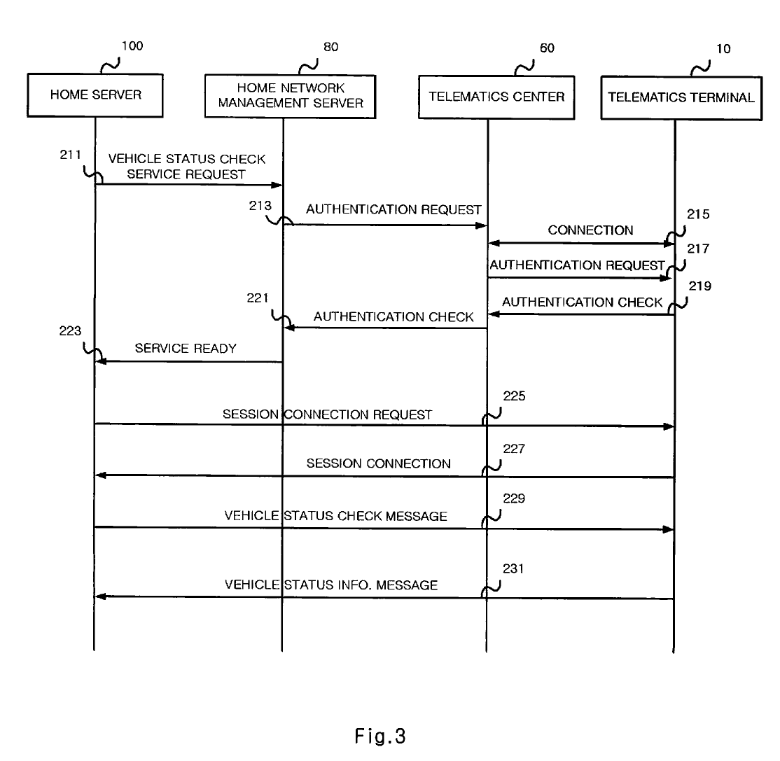

FIG. 3 is a flowchart illustrating a method for checking the vehicle status in the home telematics system according to the present invention. A description will be made with reference to FIGS. 1 to 3.

First, if the user inputs a telephone number and authentication information of the telematics terminal 10 using the home network terminal 110 or the home server 100 and requests for a vehicle status check service, the home server 100 generates a message of requesting the vehicle status check service, including the telephone number and the authentication information, and transmits the generated request message to the home network management server 80 through the complex server 90.

The home network management server 80 receives the vehicle status check service request message, detects the telephone number and the authentication information from the vehicle status check service request message, and transmits an authentication request message including the telephone number and the authentication information to the telematics center 60.

In the above description, the home network management server 80 receives the vehicle status check service request message including the telephone number and the authentication information that are inputted by the user using the home network terminal 110 or the home server 100, and receives the authentication request message. Alternately, the home network management server 80 can previously store the telephone number and the authentication information and, upon the receipt of the vehicle status check service request message, can construct the authentication request message using the previously stored telephone number and authentication information, and transmit the authentication request message to the telematics center 60.

Thus, the telematics center 60 compares the authentication information of the client information associated with the telephone number in the telematics client information database (not shown) with the authentication information included in the authentication request message, and executes authentication. If it is the authentication result that two authentication information are consistent with each other, in Step 221, the telematics center 60 transmits the authentication check message to the home network management server 80.

Alternately, the authentication can be also executed in the telematics terminal 10. The telematics terminal 10 executing the authentication, the telematics center 60 calls and connects with the telematics terminal 10 that is associated with the telephone number included in the authentication request message in Step 215, and transmits the authentication request message having the authentication information to the telematics terminal 10 in Step 217.

Thus, the telematics terminal 10 compares the authentication information previously stored in the storage unit 12 with the authentication information included in the received authentication request message, and executes the authentication. If it is the authentication result that they are consistent with each other, in Step 219, the telematics terminal 10 transmits the authentication check message to the telematics terminal 60.

Upon the receipt of the authentication check message from the telematics terminal 10, in Step 221, the telematics center 60 transmits the authentication check message to the home network management server 80.

Upon the receipt of the authentication check message, in Step 223, the home network management server 80 transmits a service ready message of informing that service ready is completed, to the home server 100.

Thus, in Step 225, the home server 100 transmits a session connection request message to the telematics terminal 10 through the complex server 90, the home network management server 80, the Internet network 70, the telematics center 60, and the wireless network 50.

In Step 227, the telematics terminal 10 transmits a session connection message to the home server 100 in response to the session connection request message. If so, in Step 229, the home server 100 transmits the vehicle status check message to the telematics terminal 10.

In Step 231, the controller 10 of the telematics terminal 100 again collects the vehicle status information, which is collected using the vehicle diagnosing unit 14 and stored in the storage unit 12, and collects the invasion information using the invasion detector 16, and transmits the vehicle status information message including the collected vehicle status information and invasion information to the home server 100.

Thus, the home server 100 analyzes the vehicle status information and the invasion information from the vehicle status information message, transmits the analyzed result to the home network terminal 110, and displays the analyzed result on the home network terminal 100 or a display unit (not shown) of the home server itself for the user.

As described above, the present invention has an advantage of checking the status of the vehicle positioned at a parking lot or a remote place, using the home network terminal and the home server.

Thus, the present invention has an advantage of preventing a battery discharge when the vehicle parks with the light turning on, and preventing a theft when the vehicle parks with the door unlocked.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A method for checking a vehicle status in a home telematics system having a home network terminal, a home server, a home network management server, a telematics center, and a telematics terminal, the method comprising steps of:
in the home server, requesting the home network terminal for a vehicle state check service;
in the home network management server, transmitting an authentication request message having a telephone number and authentication information of the telematics terminal, to the telematics center;
in the telematics center, comparing authentication information of the telematics terminal associated with the telephone number, with the authentication information of the authentication request message, and executing authentication;
in the home network management server, upon success of the authentication, transmitting a service ready message of informing that service is ready, to the home server;
in the home server, sending a session connection request to the telematics terminal, and executing session connection;
in the home server, transmitting a vehicle status check message to the telematics terminal in a session connection state; and
in the telematics terminal, receiving the vehicle status check message, collecting vehicle status information, and transmitting a vehicle status information message having the collected vehicle status information, to the home server.

2. The method according to claim 1, wherein, when the vehicle status check service is requested, the telephone and the authentication information are inputted by a user using the home server.

3. The method according to claim 1, wherein the telephone number and the authentication information are information previously stored in the home network management server for the home server.
